(19) United States
(12) Patent Application Publication
(10) Pub. No.: US 2017/0185520 A1
(43) Pub. Date: Jun. 29, 2017

(54) INFORMATION PROCESSING APPARATUS AND CACHE CONTROL METHOD

(71) Applicant: FUJITSU LIMITED, Kawasaki-shi (JP)

(72) Inventor: Yuki MATSUO, Bunkyo (JP)

(73) Assignee: FUJITSU LIMITED, Kawasaki-shi (JP)

(21) Appl. No.: 15/375,697

(22) Filed: Dec. 12, 2016

(30) Foreign Application Priority Data
Dec. 24, 2015 (JP) 2015-251547

(51) Int. Cl. G06F 12/0862

(52) U.S. Cl. CPC G06F 12/0862; G06F 2212/602

(57) ABSTRACT

An information processing apparatus includes a plurality of memory blocks, each of the plurality of memory blocks managed with either a first list or a second list, respectively; and a controller configured to refer a first memory block managed with a first list, maintain management of the first memory block with the first list if data of the first memory block is data that has been prefetched, and change an list with which the first memory block is managed from the first list to a second list if the data of the first memory block is data that has not been prefetched.

### CROSS-REFERENCE TO RELATED APPLICATION

This application is based upon and claims the benefit of priority of the prior Japanese Patent Application No. 2015-251547, filed on Dec. 24, 2015, the entire contents of which are incorporated herein by reference.

### FIELD

The embodiments discussed herein are related to an information processing apparatus and a cache control method.

### BACKGROUND

Various devices for storing data are currently used. For example, in some cases, a storage is provided with cache memory capable of being accessed more quickly than the storage. In such a case, data that is highly likely to be accessed in the future is read from the storage and is stored in the cache. When the corresponding data is requested, the data is read from the cache memory and is sent to the request source. This speeds up data access.

The storage capacity of cache memory is limited. Therefore, an algorithm called a least recently used (LRU) algorithm may be used to manage the resources of cache memory. For example, a way to manage cache memory is provided in which, for data in the cache, the longer the time since the previous usage of the data, the lower the LRU priority assigned to the data. At the time of recording new data to cache memory, if there is no free space in the cache memory, data with the lowest LRU priority is evicted from the cache memory, and new data is stored as data with the highest LRU priority in the cache memory. Alternatively, instead of unconditionally giving the highest priority to new data, deriving the next LRU priority by using the current LRU priority of data, the attributes of data, or the like is conceived. In addition, a proposal has been made in which, when it is determined that data to be read has a sequential nature and the data is prefetched, the prefetch size and the prefetch amount are dynamically varied in accordance with the remaining capacity of cache memory.

Related techniques are disclosed in, for example, Japanese Laid-open Patent Publication No. 2000-347941 and Japanese Laid-open Patent Publication No. 2008-225914.

With the LRU algorithm, memory blocks may be managed with data of a list structure called an LRU list. In this case, a way of using a plurality of LRU lists is conceivable in which data with a relatively small number of accesses and data with a relatively large number of accesses are managed with a first LRU list and with a second LRU list, respectively and separately. Accordingly, for example, as the size of the second LRU list is increased, the time during which useful data with a relatively large number of accesses remains in cache memory is increased.

### SUMMARY

According to an aspect of the invention, an information processing apparatus includes a plurality of memory blocks, each of the plurality of memory blocks managed with either a first list or a second list, respectively, the first list storing information of a memory block storing a data read from a storage, the second list storing information of a memory block storing a data having a cache hit; and a controller configured to refer a first memory block managed with a first list, maintain management of the first memory block with the first list if data of the first memory block is data that has been prefetched, and change an list with which the first memory block is managed from the first list to a second list if the data of the first memory block is data that has not been prefetched.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an information processing apparatus of a first embodiment;

FIG. 2 is a diagram illustrating an example of hardware of a storage of a second embodiment;

FIG. 3 is a diagram depicting an example of cache pages;

FIG. 4 is a diagram illustrating an example of an access pattern of prefetched data;

FIG. 5 is a diagram illustrating an example of an access pattern of random data;

FIG. 6 is a diagram illustrating an example of functionality of a control device;

FIG. 7 is a diagram illustrating an example of page management with two LRUs;

FIG. 8 is a diagram illustrating an example of page management structures;

FIG. 9 is a diagram illustrating an example of a structure of management of pointers to the head and tail of each LRU;

FIG. 10 is a diagram illustrating an example of a management structure of a pointer to the head of FreeList;

FIG. 11 is a diagram illustrating an example of a manner in which page management structures are linked to LRUx;

FIG. 12 is a diagram illustrating an example of a manner in which page management structures are linked to FreeList;

FIG. 13 is a diagram depicting an example of a parameter that is used by a replacement page determination unit;

FIG. 14A and FIG. 14B are diagrams illustrating an example of parameters that are used by a prefetch controller;

FIG. 15 is a flowchart illustrating an example of a cache hit determination;

FIG. 16 is a flowchart illustrating an example of a replacement page determination;

FIG. 17 is a flowchart illustrating an example of prefetch control; and

FIG. 18 is a diagram illustrating an example of hardware of a server computer.

### DESCRIPTION OF EMBODIMENTS

Data that has been prefetched (prefetched data) may also be stored in cache memory. Prefetching is often used for reading data that is sequentially accessed. After prefetched data is referenced one or more times in a short time period, the prefetched data is no longer referenced. When cache memory is managed in the way described above with a plurality of LRU lists, there is a possibility that the prefetched data that is no longer referenced remains in the second LRU list.

In one aspect, an object of the present disclosure is to provide an information processing apparatus, a cache control program, and a cache control method for reducing the remaining prefetched data.

Hereinafter, embodiments of the present disclosure will be described with reference to the accompanying drawings.

### First Embodiment

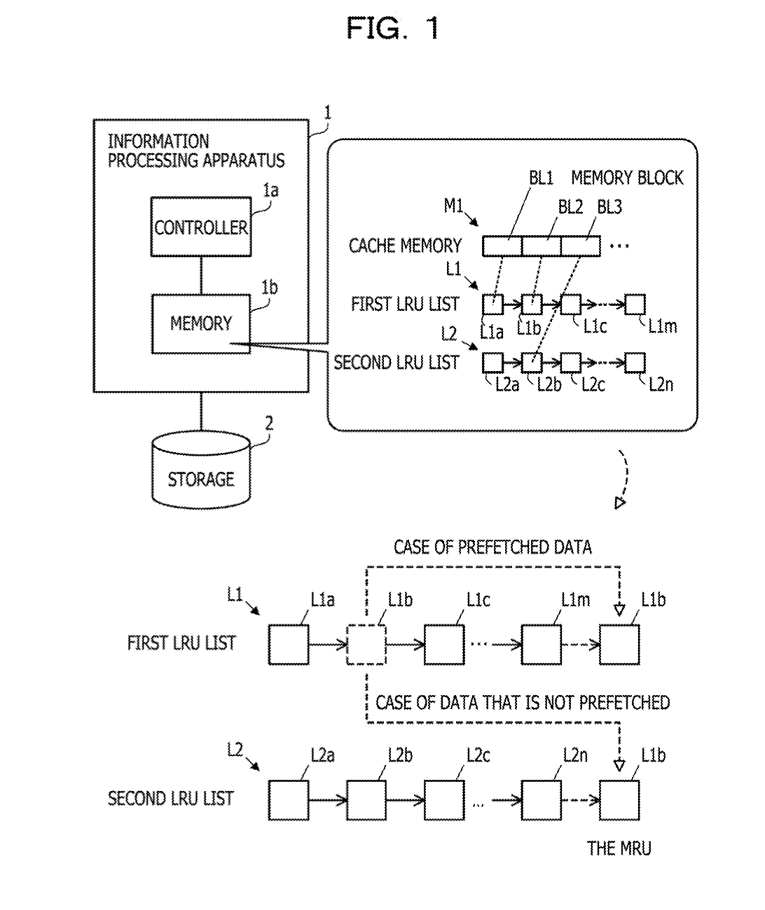

FIG. 1 is a diagram illustrating an information processing apparatus of a first embodiment. An information processing apparatus 1 includes a controller 1a and memory 1b. The information processing apparatus 1 is coupled to a storage 2. The storage 2 may be provided externally to the information processing apparatus 1. The storage 2 may be provided internally to the information processing apparatus 1. The storage 2 is, for example, an auxiliary storage of the information processing apparatus 1. The storage 2 may be, for example, a hard disk drive (HDD).

The controller 1a may include a central processing unit (CPU), a digital signal processor (DSP), an application specific integrated circuit (ASIC), a field programmable gate array (FPGA), or the like. The controller 1a may be a processor that executes a program. The term “processor” may include a set of a plurality of processors (a multiprocessor). The memory 1b is the main storage of the information processing apparatus 1. The memory 1b may be one called random access memory (RAM). The information processing apparatus 1 may be one called a computer.

The controller 1a accesses data stored in the storage 2. For example, the controller 1a accepts an access request for data issued by application software that is executed by the information processing apparatus 1. Alternatively, the controller 1a may accept an access request for data from another computer (not illustrated in FIG. 1) coupled via a network to the information processing apparatus 1. The controller 1a reads data requested by an access request from the storage 2, and issues a response to the request source (another computer coupled via software or a network on the information processing apparatus 1).

The memory 1b is used as cache memory M1. In particular, the memory 1b includes a plurality of memory blocks BL1, BL2, BL3, . . . . Each of the memory blocks BL1, BL2, BL3, . . . is one unit of a storage area that is available in the memory 1b. For example, each of the memory blocks BL1, BL2, BL3, . . . has a common given-size storage capacity. The cache memory M1 is a set of the memory blocks BL1, BL2, BL3, . . . .

The controller 1a may speed up access to data by using the cache memory M1.

First, upon detecting sequential access to the storage 2 based on access requests, the controller 1a predicts data to be accessed in the future in the storage 2, and prefetches the predicted data in the cache memory M1 before this data is accessed. Here, the sequential access refers to data access in which addresses to be accessed in the storage 2 are consecutive (not necessarily completely consecutive). It is said that the prefetched data is data that is highly likely to be accessed in the future.

Second, when, in accordance with an access request, reading data that is not stored in the cache memory M1 from the storage 2 and making a response, the controller 1a stores the data in the cache memory M1. This is because this data is highly likely to be accessed again by the access request source or the like. Data that is stored in cache memory in such a manner may be called random data in contrast to the above-described data that is prefetched (data that is sequentially accessed).

The controller 1a manages the memory blocks BL1, BL2, BL3, . . . included in the cache memory M1 by using an LRU algorithm. Alternatively, data read from the storage 2 is stored in each of the memory blocks BL1, BL2, BL3, . . . . Therefore, it is possible to say that the controller 1a manages data stored in each of the memory blocks BL1, BL2, BL3, . . . by using an LRU algorithm.

The controller 1a uses an LRU list for management of each of the memory blocks BL1, BL2, BL3, . . . . The LRU list is, for example, data having a data structure in which list elements called structures are coupled in order by pointers. For example, the list element at the head of an LRU list corresponds to the LRU (among memory blocks belonging to the LRU list, a memory block with the longest time since the last access, or data stored in this memory block). Conversely, the list element at the tail of the LRU list corresponds to the LRU (among memory blocks belonging to the LRU list, a memory block that is last accessed, or data stored in this memory block). When storing new data in the cache memory M1, the controller 1a stores the new data in a memory block corresponding to the list element at the LRU (head) of the LRU list if there is no free space in the cache memory M1 (old data in the corresponding memory block is erased).

Here, the controller 1a uses two LRU lists. The first one is a first LRU list L1. The second one is a second LRU list L2. For example, the first LRU list L1 and the second LRU list L2 include the following list elements at some time point.

The first LRU list L1 includes list elements L1a, L1b, L1c, . . . , L1m. The list elements L1a, L1b, L1c, . . . , L1m are coupled in this order by pointers. The list element L1a is the head of the first LRU list L1. The list element L1m is the tail of the first LRU list L1.

The second LRU list L2 includes list elements L2a, L2b, L2c, . . . , L2n. The list elements L2a, L2b, L2c, . . . , L2n are coupled in this order by pointers.

Each of the memory blocks BL1, BL2, BL3, . . . is associated with a list element of the first LRU list L1 or the second LRU list L2. For example, the memory block BL1 is associated with the list element L1a. The memory block BL2 is associated with the list element L1b. The memory block BL3 is associated with the list element L2b.

The first LRU list L1 is used for management of a memory block to which data newly read from the storage 2 has been written. For example, the controller 1a manages a memory block in which data that has been prefetched and random data for which the number of cache hits is zero are stored, with the first LRU list L1.

The second LRU list L2 is used for management of a memory block to which data with an actual result of a cache hit is written. For example, with the second LRU list L2, the controller 1a manages a memory block in which data with the number of cache hits greater than or equal to one is stored, among memory blocks managed with the first LRU list L1. Accordingly, increasing the size of the second LRU list L2 to be larger than the size of the first LRU list L1 enables data stored in a memory block managed with the second LRU list L2 to remain long in the cache memory M1.

There is a way called adaptive replacement cache (ARC) as a method for managing memory blocks in which an LRU list for protecting data with a large number of hits and an LRU list for the other data are provided so as to protect useful data for which many cache hits occur.

In contrast, the controller 1a performs control as follows.

When a first memory block managed with the first LRU list L1 is referenced, the controller 1a determines whether the data of the first memory block is prefetched data. If the data of the first memory block is prefetched data, the controller 1a maintains the management of the first memory block with the first LRU list L1. If the data of the first memory block is data that has not been prefetched, the controller 1a changes the LRU list for managing the first memory block from the first LRU list L1 to the second LRU list L2.

For example, it is assumed that the controller 1a accepts an access request for data stored in the memory block BL2 (corresponding to the first memory block mentioned above). In this case, the controller 1a detects that the requested data is stored in the memory block BL2. The controller 1a then determines whether the data stored in the memory block BL2 is prefetched data. For example, when storing the data in question in the memory block BL2, the controller 1a may set identification information denoting whether this data is data that has been prefetched to be stored in the memory block BL2, in the list element L1b corresponding to the memory block BL2. Consequently, by referencing the list element L1b, the controller 1a is able to determine whether data stored in the memory block BL2 is prefetched data.

If the data stored in the memory block BL2 is prefetched data, the controller 1a moves the list element L1b corresponding to the memory block BL2 to the tail of the first LRU list L1. In more particular, the controller 1a sets the address of the list element L1b in a pointer indicating the next list element of the list element L1m. The controller 1a sets the address of the list element L1c in a pointer indicating the next list element of the list element L1a. That is, the controller 1a maintains management with the first LRU list L1 of the memory block BL2.

If the data stored in the memory block BL2 is data that has not been prefetched (if the data is not data that has been prefetched), the controller 1a moves the list element L1b corresponding to the memory block BL2 to the tail of the second LRU list L2. In more particular, the controller 1a sets the address of the list element L1b in a pointer indicating the list element next to the list element L2n. The controller 1a sets the address of the list element L1c in a pointer indicating the list element next to the list element L1a. That is, the controller 1a changes the LRU list for managing the memory block BL2 from the first LRU L1 to the second LRU list L2.

In such a way, the controller 1a maintains, among data managed with the first LRU list L1, the management with the first LRU list L1 for prefetched data even when a cache hit has occurred for the prefetched data. That is, the controller 1a does not change the management for a memory block in which the prefetched data is stored, to management with the second LRU list L2 even when a cache hit occurs in this memory block.

It is conceivable that prefetched data and random data are equally handled. That is, it is conceivable that, for a memory block in which the prefetched data is stored, the management is shifted in response to a cache hit from the first LRU list L1 to the second LRU list L2. However, in this case, there is an increased possibility that data that is no longer referenced will remain in the cache memory M1. Prefetched data is often used for reading data that is sequentially accessed (for example, data that is streamed, or the like), and thus, in many cases, the prefetched data is no longer referenced after being referenced one or more times in some short time period.

Therefore, for a memory block in which prefetched data is stored, the controller 1a reduces shifts between LRU lists to cause the memory block to remain under the management with the first LRU list L1, thereby reducing management of the memory block with the second LRU list L2. With the second LRU list L2, the controller 1a manages a memory block in which random data with an actual result of a cache hit is stored, and does not manage a memory block in which prefetched data is stored. Thus, the list element of a memory block in which prefetched data is stored is inhibited from remaining in the second LRU list L2. Accordingly, prefetched data may be inhibited from remaining in the cache memory M1, and thus the cache memory M1 may be efficiently used.

### Second Embodiment

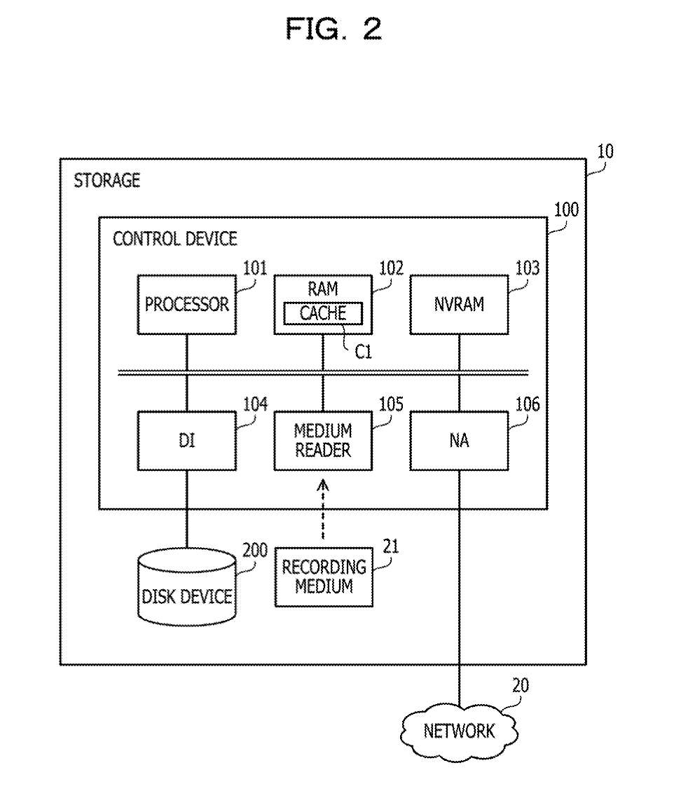

FIG. 2 is a diagram illustrating an example of hardware of a storage of a second embodiment. A storage 10 includes a control device 100 and a disk device 200. The control device 100 may be a device called a controller manager (CM) or simply called a controller. The control device 100 controls data access to the disk device 200. The control device 100 is an example of the information processing apparatus 1 of the first embodiment.

The disk device 200 includes one or a plurality of HDDs. The disk device 200 may be a device called a drive enclosure, a disk shelf, or the like. The control device 100 may implement a logical storage area by combining a plurality of HDDs included in the disk device 200 by using the redundant arrays of independent disks (RAID) technology. The storage 10 may include, together with the disk device 200, another type of storage such as a solid state drive (SSD).

The control device 100 includes a processor 101, RAM 102, nonvolatile RAM (NVRAM) 103, a drive interface (DI) 104, a medium reader 105, and a network adapter (NA) 106. Each unit is coupled to a bus of the control device 100.

The processor 101 controls information processing of the control device 100. The processor 101 may be a multiprocessor. The processor 101 is, for example, a CPU, a DSP, an ASIC, an FPGA, or the like. The processor 101 may be a combination of two or more elements among a CPU, a DSP, an FPGA, and the like.

The RAM 102 is a main storage of the control device 100. The RAM 102 temporarily stores at least some of the programs of an operating system (OS) and firmware that the processor 101 is caused to execute. The RAM 102 also stores various kinds of data for use in processing executed by the processor 101. The RAM 102 is, for example, dynamic RAM (DRAM).

The RAM 102 is provided with cache memory (referred to as cache) C1 for storing data read from the disk device 200. The cache C1 is a set of a plurality of memory blocks into which a certain storage area in the RAM 102 is divided by a given size. In some cases, the memory block is referred to as a cache page or a page. That is, it is said that the cache C1 is a set of a plurality of cache pages (or a plurality of pages).

The NVRAM 103 is an auxiliary storage of the control device 100. The NVRAM 103 stores an OS program, firmware programs, and various kinds of data.

The DI 104 is an interface for communication with the disk device 200. For example, an interface such as a serial attached SCSI (SAS) may be used as the DI 104. Note that SCSI is an abbreviation for small computer system interface.

The medium reader 105 is a device that reads a program or data recorded on a recording medium 21. As the recording medium 21, for example, nonvolatile semiconductor memory such as a flash memory card may be used. The medium reader 105, for example, follows an instruction from the processor 101 to cause the program or data read from the recording medium 21 to be stored in the RAM 102 or the NVRAM 103.

The NA 106 performs communication with another device via the network 20. For example, a computer (not illustrated in FIG. 2) that performs transactions using data stored in the storage 10 is coupled to the network 20. In that case, the NA 106 receives an access request for data stored in the disk device 200 via the network 20 from this computer.

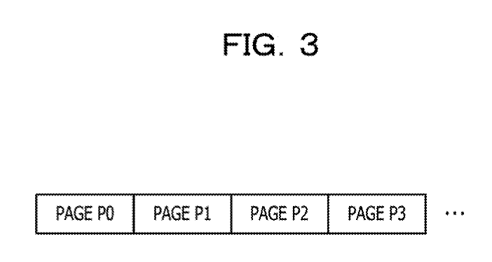

FIG. 3 is a diagram depicting an example of cache pages. The cache C1 includes a plurality of cache pages (referred to simply as pages). The pages are management units of the cache C1 into which the storage area of the cache C1 is divided by a certain size. The cache C1 includes pages P0, P1, P2, P3, . . . .

For example, upon occurrence of a cache miss for some access request, the processor 101 acquires data from the disk device 200 and stores the data in the cache C1. Alternatively, in some cases, the processor 101 prefetches certain data from the disk device 200 to store the data in the cache C1. In either case, when there is no free space in the cache C1, any page is selected and data is replaced. The control device 100 uses an LRU algorithm in order to determine what page is to be used for the replacement.

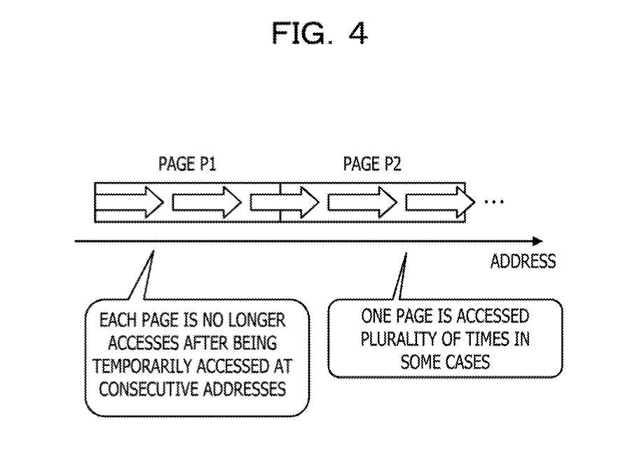

FIG. 4 is a diagram depicting an example of an access pattern of prefetched data. The processor 101 reads in advance data that is consecutively accessed and is predicted to have a read request in the future, from the disk device 200 and stores the data in the cache C1, so that the response time to a read request for the data is reduced. Such an approach is called a prefetch of data. To perform a prefetch is referred to as prefetching in some cases. However, since the data that has been prefetched (prefetched data) is data to which access is predicted and that is stored in the cache C1, it is uncertain at the time of prefetching whether the prefetched data will be actually used.

In addition, since prefetched data is data that is sequentially accessed, the prefetched data is temporarily accessed during a certain time period in many cases. That is, after each page is temporarily accessed at consecutive addresses, the page is no longer accessed. Note that, during this time period, one page is accessed a plurality of times in some cases.

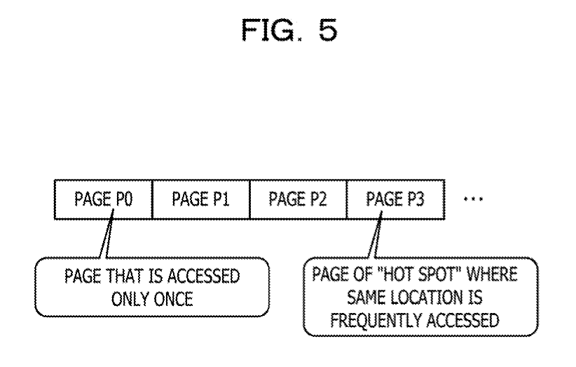

FIG. 5 is a diagram illustrating an example of an access pattern of random data. In contrast to the above-described data that is sequentially accessed, data that is accessed at random may be called random data. Upon occurrence of a cache miss for some access request, random data is read from the disk device 200 by the processor 101 and is stored in the cache C1. Access to random data stored in the cache C1 is various types of access. Therefore, in accordance with later access situations for the random data, a page that is accessed only once, and a page that is a so-called “hot spot”, which is the same location (page) frequently accessed, are present.

The control device 100 provides functionality for efficiently managing each page of the cache C1 in which prefetched data and random data are stored in this way.

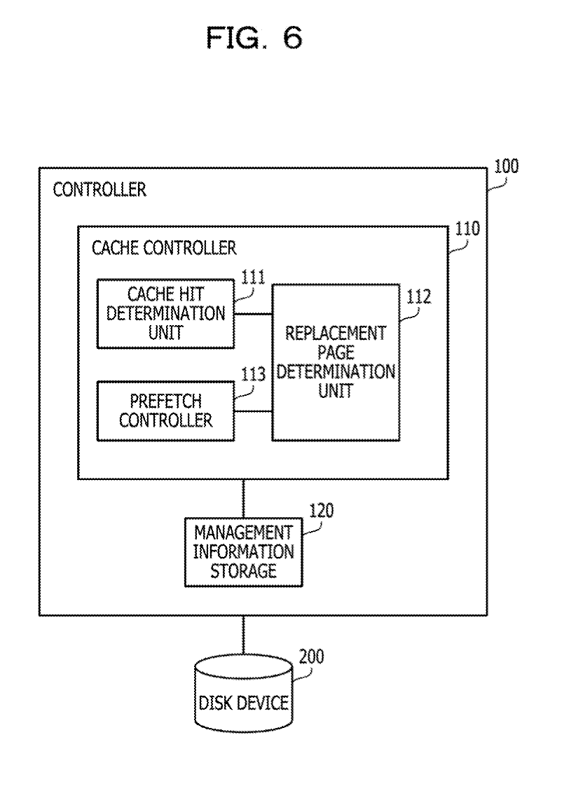

FIG. 6 is a diagram illustrating an example of functionality of a control device. The control device 100 includes a cache controller 110 and a management information storage unit 120. The functionality of the cache controller 110 is performed by a program stored in the RAM 102 being executed by the processor 101. The management information storage unit 120 is implemented as a storage area secured for the RAM 102 or the NVRAM 103.

The cache controller 110 receives an access request for data stored in the disk device 200. The access request is, for example, issued by a computer coupled to the network 20. When a cache miss has occurred, the cache controller 110 reads data requested by the disk device 200, provides a response to the access request source, and stores the data in the cache C1. When a cache hit has occurred, the cache controller 110 provides data read from the cache C1 as a response to the access request source. The cache controller 110 manages a plurality of pages included in the cache C1 with two LRU lists. The first LRU list is called “LRU1”. The second LRU list is called “LRU2”. In each of the LRU lists managed by the cache controller 110, the head element corresponds to the LRU, and the tail element corresponds to the MRU.

The cache controller 110 includes a cache hit determination unit 111, a replacement page determination unit 112, and a prefetch controller 113.

The cache hit determination unit 111 determines whether there is data requested by an access request in the cache C1 (a cache hit) or there is no such data in the cache C1 (a cache miss).

If there is a cache hit, the cache hit determination unit 111 reads the requested data from the cache C1 and transmits the data to the access request source. At this point, the cache hit determination unit 111 varies operations for LRU1 and LRU2 depending on whether the requested data is read from a page managed with LRU1 or the requested data is read from a page managed with LRU2.

First, when data is read from a page managed with LRU1, the operations are as follows. At this point, if the read data is prefetched data, the cache hit determination unit 111 maintains management with LRU1 for the page in which the prefetched data is stored. That is, the cache hit determination unit 111 moves the list element of this page to the MRU (tail) of LRU1. On the other hand, if read data is not prefetched data, the cache hit determination unit 111 changes the LRU list for managing a page in which the data is stored, from LRU1 to LRU2. That is, the cache hit determination unit 111 moves the list element of the page to the MRU (tail) of the LRU2.

Next, when data is read from a page managed with LRU2, the operations are as follows. At this point, the read data is not prefetched data but is random data. The cache hit determination unit 111 moves the list element of the page in which the data is stored, to the MRU (tail) of LRU2.

When a cache miss has occurred, the cache hit determination unit 111 reads the requested data (random data) from the disk device 200 and transmits this data to the access request source. When a cache miss has occurred, the cache hit determination unit 111 acquires a new page of the cache C1 from the replacement page determination unit 112 and stores the data read from the disk device 200 in this page. At this point, the cache hit determination unit 111 operates LRU1 to couple a list element corresponding to the page in which new data is stored, to the MRU (tail) of LRU1.

In response to a request for a new page from the cache hit determination 111 or the prefetch controller 113, the replacement page determination unit 112 provides any page of the cache C1 to the cache hit determination unit 111 or the prefetch controller 113 serving as the request source. When there is a free page in the cache C1, the replacement page determination unit 112 provides the free page. When there is no free page in the cache C1, the replacement page determination unit 112 determines a page to be replaced based on LRU1 or LRU2.

The prefetch controller 113 detects sequential access to data stored in the disk device 200 and performs prefetching. When performing prefetching, the prefetch controller 113 acquires a new page for storing prefetched data from the replacement page determination unit 112 and stores prefetched data in the page.

The management information storage unit 120 stores various kinds of data used for processing of the cache hit determination unit 111, the replacement page determination unit 112, and the prefetch controller 113. For example, the management information storage unit 120 stores LRU1 and LRU2 described above. In addition, the management information storage unit 120 stores parameters for the prefetch controller 113 to detect sequential access.

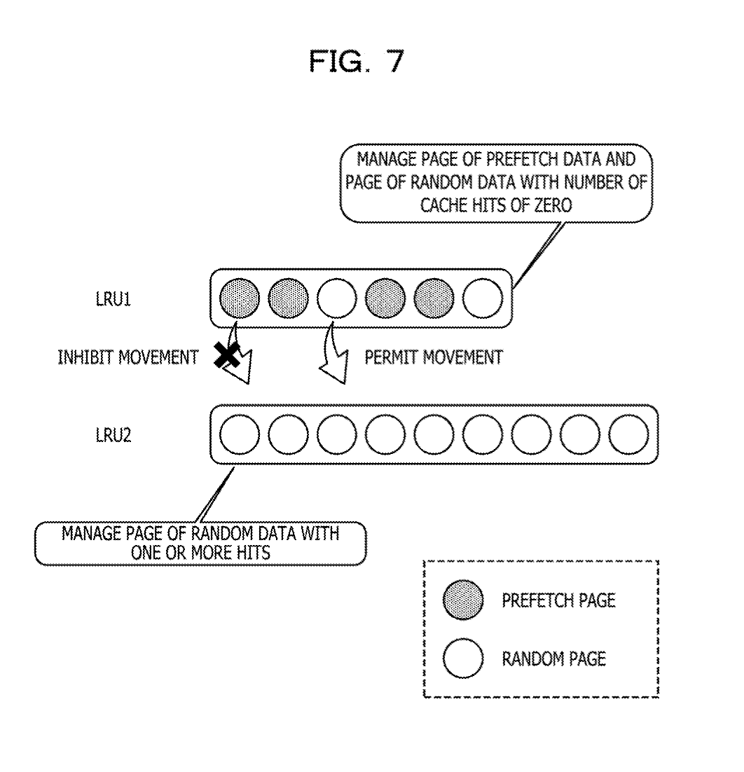

FIG. 7 is a diagram illustrating an example of page management with two LRUs. As described above, the cache controller 110 manages data stored in the cache C1 with two LRU lists (LRU1 and LRU2). In FIG. 7, a page in which prefetched data is stored is referred to as a prefetch page. In addition, the page in which random data is stored is referred to as a random page.

The cache controller 110 manages the page of prefetched data (the prefetch page) and the page of random data (random page) with zero cache hits by using LRU1. The cache controller 110 manages the page of random data (the random page) with one or more cache hits by using LRU2.

In particular, when a page managed with LRU1 is referenced, the cache hit determination unit 111 maintains management of this page with LRU1 if data stored in the page is prefetched data. This processing may be represented as follows. That is, when a page managed with LRU1 is referenced, the cache hit determination unit 111 maintains management of this page with LRU1 if the page is a prefetch page.

When a page managed with LRU1 is referenced, on the other hand, the cache hit determination unit 111 changes the LRU list for managing this page from LRU1 to LRU2 if data stored in the page is not prefetched data (if the data is random data). This processing may be represented as follows. That is, when a page managed with LRU1 is referenced, the cache hit determination unit 111 changes the LRU list for managing this page from LRU1 to LRU2 if the page is not a prefetch page (if the page is a random page).

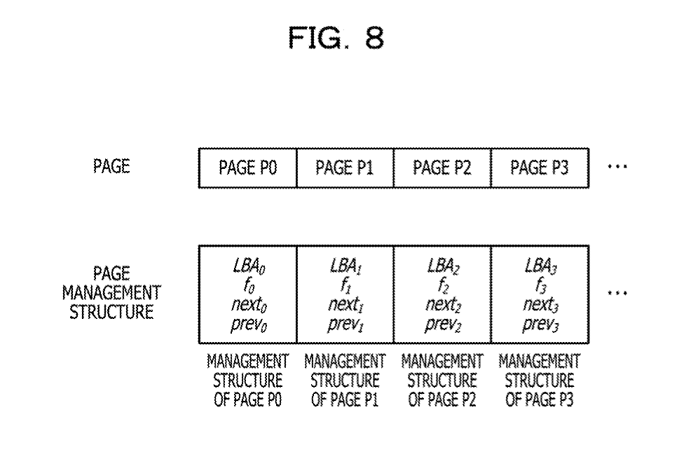

FIG. 8 is a diagram illustrating an example of page management structures. The page management structures are list elements of an LRU list and FreeList (a list for management of free pages) described below. In FIG. 8, pages P0, P1, P2, P3, . . . in the cache C1 are also illustrated to help better understanding of the correspondence between each page management structure and a page.

One page management structure is provided for each of the pages P0, P1, P2, P3, . . . . Each page management structure is stored in the management information storage unit 120 (that is, a given storage area on the RAM 102).

The page management structure includes a logical block address (LBA), a flag f, a pointer next indicating the next page management structure, and a pointer prev indicating the previous page management structure.

This LBA is the LBA in the disk device 200 of data stored in the page in question. When the page is free, the LBA is unset (null).

The flag f is identification information denoting whether data stored in the corresponding page is prefetched data. If the data is prefetched data, the flag f is “true” (or may be represented as “1”). If the data is not prefetched data, the flag f is “false” (or may be represented as “0”). When the page is free, the flag f is “false”.

The pointer next is information indicating the address of the RAM 102 at which the next page management structure is stored. The pointer prev is information indicating the address of the RAM 102 at which the previous page management structure is stored.

For example, in FIG. 8, the LBA=LBA₀, the flag f=f₀, the pointer next=next₀, and the pointer prev=prev₀ are set for the page management structure of the page P0 (abbreviated as a management structure in FIG. 8). Likewise, the LBA, the flag f, the pointer next, and the pointer prev are set for the page management structure of another page.

Here, adding a page management structure corresponding to a certain page in a certain LRU list may be represented as “registering the corresponding page in an LRU list”.

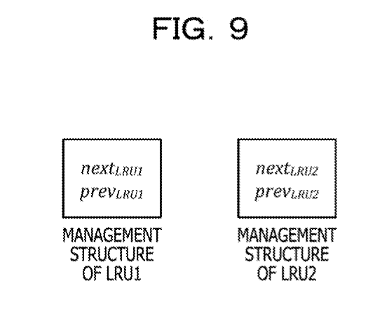

FIG. 9 is a diagram illustrating an example of a management structure of pointers to the head and tail of each LRU. The management structure of pointers to the head and tail of each LRU is provided for each of LRU1 and LRU2. The management structure of pointers to the head and tail of LRU1 is referred to as a “management structure of LRU1”. The management structure of pointers to the head and tail of LRU2 is referred to as a “management structure of LRU2”. The management structure of LRU1 and the management structure of LRU2 are stored in the management information storage unit 120.

The management structure of LRU1 includes pointer next_{LRU1} and pointer prev_{LRU1}. Pointer next_{LRU1} is information indicating the address of the RAM 102 at which the page management structure of the head of LRU1 is stored. Pointer prev_{LRU1} is information indicating the address of the RAM 102 at which the page management structure of the tail of LRU1 is stored.

The management structure of LRU2 includes pointer next_{LRU2} and pointer prev_{LRU2}. Pointer next_{LRU2} is information indicating the address of the RAM 102 at which the page management structure of the head of LRU2 is stored. Pointer prev_{LRU2} is information indicating the address of the RAM 102 at which the page management structure of the tail of LRU2 is stored.

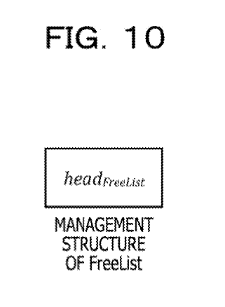

FIG. 10 is a diagram illustrating an example of a management structure of a pointer to the head of FreeList. The management structure of a pointer to the head of FreeList is provided for a list called FreeList. FreeList is a list for management of free pages in the cache C1. The management structure of a pointer to the head of FreeList is referred to as a “management structure of FreeList”. The management structure of FreeList is stored in the management information storage unit 120.

The management structure of FreeList includes pointer head_{FreeList}. The pointer head_{FreeList} is information indicating the address of the RAM 102 at which the page management structure of the head of FreeList is stored.

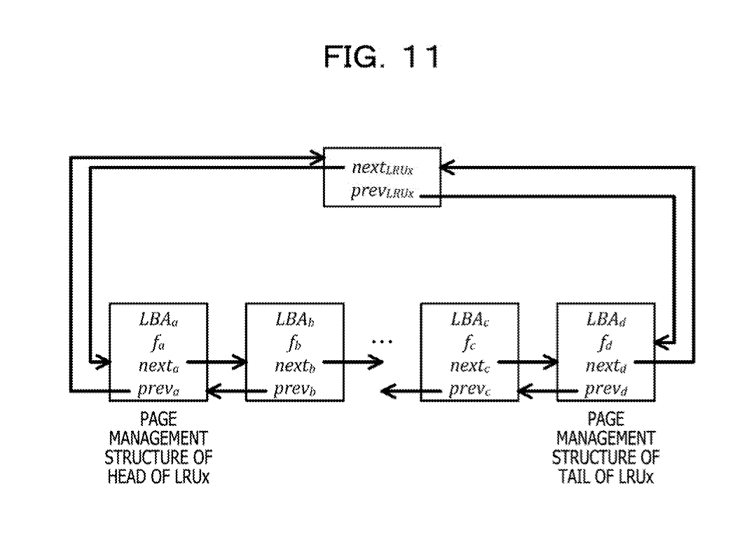

FIG. 11 is a diagram illustrating an example of a manner in which page management structures are linked to LRUx. LRUx in FIG. 11 represents either of “LRU1” and “LRU2”. Each of LRU1 and LRU2 has a list structure in which page management structures are linked with pointers.

For example, tracking the pointers next of the page management structures, with the use of pointer next_{LRU1} of the management structure of LRU1 as the starting point, results in tracking management structures in order from the management structure of the head of LRU1 to the management structure of the tail of LRU1. The pointer next of the page management structure of the tail of LRU1 indicates the management structure of LRU1.

Likewise, tracking the pointers prev of page management structures, with the use of pointer prev_{LRU1} of the management structure of LRU1 as the starting point, results in tracking management structures in order from the page management structure of the tail of LRU1 to the page management structure of the head of LRU1. The pointer prev of the page management structure of the head of LRU1 indicates the management structure of LRU1.

In addition, for example, tracking the pointers next of page management structures, with the use of pointer next_{LRU2} of the management structure of LRU2 as the starting point, results in tracking management structures in order from the page management structure of the head of LRU2 to the page management structure of the tail of LRU2. The pointer next of the page management structure of the tail of LRU2 indicates the management structure of LRU2.

Likewise, tracking the pointers prev of page management structures, with the use of pointer prev_{LRU2} of the management structure of LRU2 as the starting point, results in tracking management structures in order from the page management structure of the tail of LRU2 to the page management structure of the head of LRU2. The pointer prev of the page management structure of the head of LRU2 indicates the management structure of LRU2.

The cache controller 110 changes the setting of a pointer included in each structure, thereby making it possible to change the coupling order of page management structures coupled to LRU1 and LRU2. When changing the page management structure of the head or tail of LRUx, the cache controller 110 changes the settings of pointer next_{LRUx} and pointer prev_{LRUx} included in the management structure of LRUx so that these pointers indicate the target page management structure.

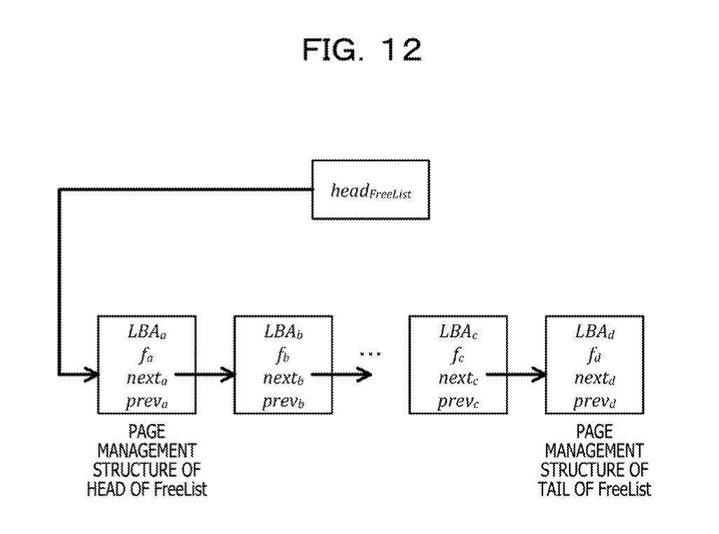

FIG. 12 is a diagram illustrating an example of a manner in which page management structures are linked to FreeList. FreeList has a list structure in which page management structures are coupled by pointers.

For example, tracking the pointers next of page management structures, with the use of pointer head_{FreeList} of the management structure of FreeList as the starting point, results in tracking page management structures in order from the page management structure of the head of FreeList to the page management structure of the tail of FreeList. Page management structures belonging to FreeList do not have to manage the pointers prev. This is because when data is stored in the cache C1, pages only have to be used from a page corresponding to the page management structure of the head of FreeList. Accordingly, in the page management structures belonging to FreeList, the pointers prev are unset (null).

As described above, the lists for coupling page management structures are three systems in total, LRU1, LRU2, and FreeList. One page management structure belongs to any list among LRU1, LRU2, and FreeList (immediately after the storage 10 is powered on, each page is in a free state and thus belongs to FreeList).

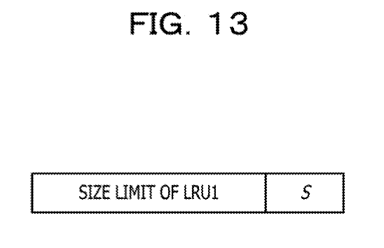

FIG. 13 is a diagram depicting an example of a parameter that is used by a replacement page determination unit. The replacement page determination unit 112 uses a size limit S of LRU1. The size limit S is a value defining the maximum size of LRU1. For example, the size limit S is represented by the number of page management structures belonging to LRU1 (the number of pages belonging to LRU1). The size limit S is stored in advance in the management information storage unit 120.

Note that the management information storage unit 120 also stores in advance the size limit of LRU2. The size limit of LRU2 has a value larger than the size limit S of LRU1.

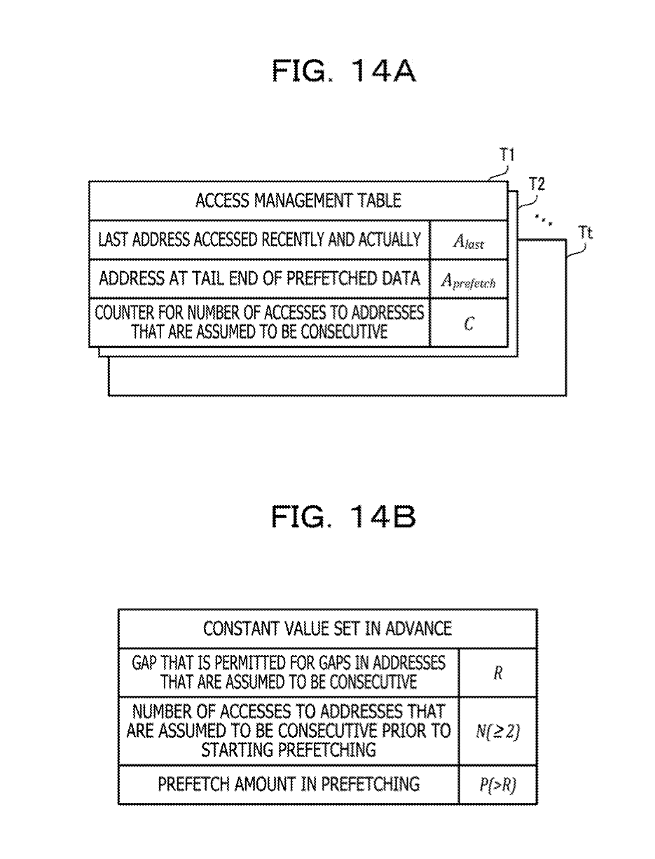

FIG. 14A and FIG. 14B are diagrams illustrating examples of parameters that are used by a prefetch controller. FIG. 14A illustrates access management tables T1, T2, . . . , Tt. The management information storage unit 120 stores t access management tables T1, T2, . . . , Tt. Here, t is an integer greater than or equal to 1. The prefetch controller 113 manages t consecutive accesses by using the access management tables T1, T2, . . . , Tt.

For example, when the storage 10 accepts access requests from a plurality of computers coupled to the network 20, it is conceivable that access issued from one computer is managed by using one access management table. Alternatively, when a plural pieces of software are executed by one computer, and software from which access has been made is able to be identified based on an access request, access issued from one piece of software on the computer may be managed by using one access management table. Hereinafter, the data structure of the access management table T1 will be described; however, the access management tables T2, . . . , Tt have data structures similar thereto.

The access management table T1 includes the last address Aₗₐₛₜ that has been actually accessed recently, address A_{prefetch} at the tail end of prefetched data, and a counter C for the number of accesses to addresses that are assumed to be consecutive.

Address Aₗₐₛₜ indicates the last logical address (the logical address accessed recently) among logical addresses of the disk device 200 requested in address requests consecutively issued by a certain single access source (the targeted access source).

Address A_{prefetch} indicates the logical address at the tail end in the disk device 200 of data that has been prefetched for access made by the targeted access source.

The counter C is a counter for counting the number of times when it is determined that the logical addresses that have been accessed are consecutive.

FIG. 14B illustrates values that are stored in advance, as constant values to be used by the prefetch controller 113, in the management information storage unit 120. First, the prefetch controller 113 uses a gap (gap size) R that is permitted for gaps in addresses that are assumed to be consecutive. Second, the prefetch controller 113 uses the number of accesses N (N is an integer greater than or equal to 2) to addresses that are assumed to be consecutive prior to starting prefetching. Third, the prefetch controller 113 uses a prefetch amount P (P is a size larger than R) in prefetching.

The gap R is a gap in logical addresses at which the disk device 200 is assumed to be sequentially accessed based on access requests sequentially issued. For example, the prefetch controller 113 may determine a gap in logical addresses that are accessed based on two consecutive access requests by obtaining a difference between the logical address at the tail of the logical address range specified in a first access request and the logical address at the head of the logical address range specified by a second access request next to the first access request. When access to logical addresses of the disk device 200 made non-consecutively to some extent is permitted as sequential access, a given size greater than one may be set for R.

The number of accesses N is a value that is compared with the value of the counter C mentioned above and is a threshold for the counter C to be counted before prefetching is performed.

The prefetch amount P is the size of data that is read from the disk device 200 during prefetching. For example, the prefetch amount P is specified as the range of logical addresses.

Next, a processing procedure performed by the control device 100 as described above will be described.

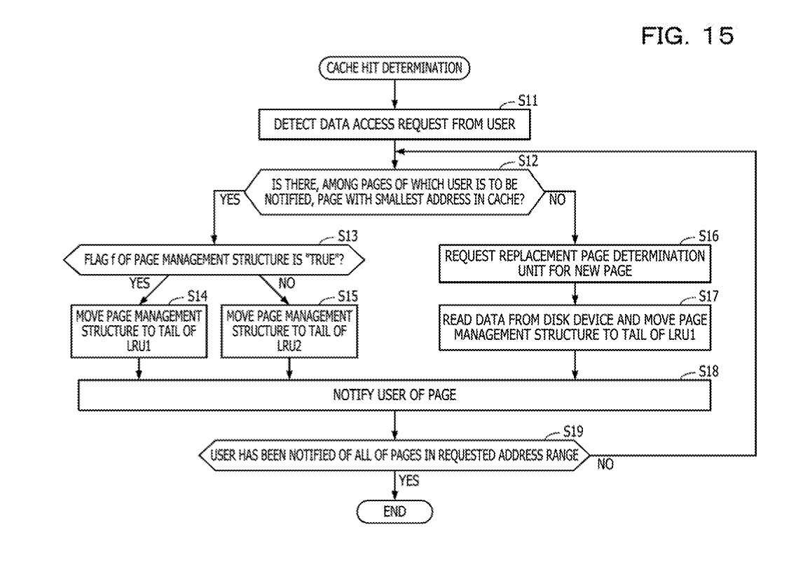

FIG. 15 is a flowchart illustrating an example of a cache hit determination. Hereinafter, description will be given of the process illustrated in FIG. 15 in accordance with step numbers.

(S11) The cache hit determination unit 111 detects an access request for data (a data access request) from the user. For example, a computer coupled via the network 20 to the storage 10 may be considered as the user mentioned here.

(S12) The cache hit determination unit 111 determines whether there is, among pages of which the user is to be notified in response to the access request, a page with the smallest address in the cache C1. If there is a page with the smallest address in the cache (a cache hit), the process proceeds to step S13. If there is no page with the smallest address in the cache (a cache miss), the process proceeds to step S16. Here, in the access request, a logical address range to be accessed in the disk device 200 is included. The smallest address is the smallest of logical addresses (logical addresses on the disk device 200) belonging to those of which the user has not yet been notified (at which target data is not provided as the response) in the range of all the logical addresses to be accessed. It is possible to determine whether there is a page in which data at the smallest address is stored, in the cache C1, by referencing an LBA value set in a page management structure by using LRU1 or LRU2 stored in the management information storage unit 120.

(S13) The cache hit determination unit 111 determines whether the flag f of a page management structure corresponding to the smallest address is “true”. If the flag f is “true”, the process proceeds to step S14. If the flag f is not “true” (that is, if the flag f is “false”), the process proceeds to step S15.

(S14) The cache hit determination unit 111 moves the corresponding page management structure to the tail (the MRU) of LRU1 (changes the settings of pointers). Further, the process proceeds to step S18.

(S15) The cache hit determination unit 111 moves the corresponding page management structure to the tail (the MRU) of LRU2 (changes the settings of pointers). At this point, the LRU list from which the corresponding page management structure moves is LRU1 in some cases. In that case, the cache hit determination unit 111 changes the LRU list for managing the corresponding page management structure from LRU1 to LRU2. Further, the process proceeds to step S18.

(S16) The cache hit determination unit 111 requests the replacement page determination unit 112 for a new page. The cache hit determination unit 111 acquires a new page from the replacement page determination unit 112.

(S17) The cache hit determination unit 111 reads data from the disk device 200 into the page, and moves the page management structure corresponding to the page concerned to the tail of LRU1 (changes the settings of pointers). That is, the cache hit determination unit 111 reads random data for which a cache miss has occurred from the disk device 200 and newly stores the random data in the cache C1. At this point, the cache hit determination unit 111 sets the logical address (setting the LBA value) from which the random data has been read (the logical address in the disk device 200), in the page management structure corresponding to the page concerned.

(S18) The cache hit determination unit 111 notifies the user of the page concerned. That is, the cache hit determination unit 111 transmits data stored in the page concerned to the user.

(S19) The cache hit determination unit 111 determines whether the user has been notified of all of the pages in the address range requested in the access request. If the user has been notified of all of the pages, the process terminates. If the user has not been notified of all of the pages (if there is a page of which the user has not yet been notified), the process proceeds to step S12.

Note that, in step S15, when moving the page management structure from LRU1 to the tail of LRU2, the cache hit determination unit 111 may release the page corresponding to the head of LRU2 and add this page to the tail of FreeList if the size of LRU2 exceeds the upper size limit for LRU2.

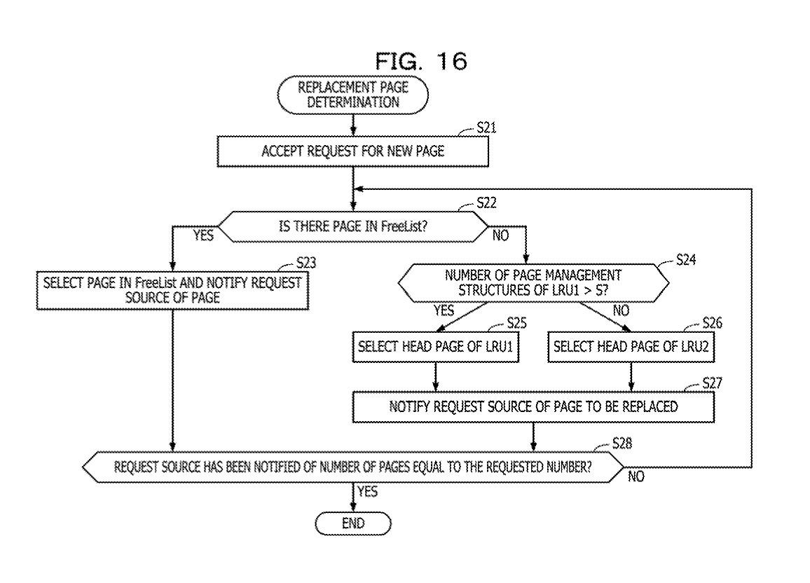

FIG. 16 is a flowchart illustrating an example of a determination of a replacement page. Hereinafter, the process illustrated in FIG. 16 will be described in accordance with step numbers.

(S21) The replacement page determination unit 112 accepts a request for a new page from the cache hit determination unit 111 or the prefetch controller 113. The replacement page determination unit 112 accepts a request for one page in some cases, and accepts a request for a plurality of pages in other cases.

(S22) The replacement page determination unit 112 references FreeList stored in the management information storage unit 120 and determines whether there is a page in FreeList. If there is a page in FreeList (if there is a page management structure belonging to FreeList), the process proceeds to step S23. If there is no page in FreeList (if there is no page management structure belonging to FreeList), the process proceeds to step S24.

(S23) The replacement page determination unit 112 selects a page in FreeList and notifies the request source (the cache hit determination unit 111 or the prefetch controller 113) of the page. The page in FreeList is the page corresponding to the page management structure of the head of FreeList (the page management structure indicated by pointer head_{FreeList}). Further, the process proceeds to S28.

(S24) The replacement page determination unit 112 determines whether the number of page management structures of LRU1 is larger than S. If the number of page management structures is larger than S, the process proceeds to step S25. If the number of page management structures is not larger than S (less than or equal to S), the process proceeds to step S26.

(S25) The replacement page determination unit 112 selects a page at the head of LRU1. In more particular, the replacement page determination unit 112 selects a page corresponding to the page management structure of the head of LRU1. The page management structure at the head of LRU1 is a page management structure indicated by pointer next_{LRU1} of the management structure of LRU1. The replacement page determination unit 112 sets the selected page as a page to be replaced. Further, the process proceeds to step S27.

(S26) The replacement page determination unit 112 selects a page at the head of LRU2. In more particular, the replacement page determination unit 112 selects a page corresponding to the page management structure of the head of LRU2. The page management structure of the head of LRU2 is a page management structure indicated by pointer next_{LRU2} of the management structure of LRU2. The replacement page determination unit 112 sets the selected page as a page to be replaced. Further, the process proceeds to step S27.

(S27) The replacement page determination unit 112 notifies the request source of the page to be replaced. The replacement page determination unit 112 initializes each set value of the page management structure corresponding to the page to be replaced to the initial value (the value that is set when the page is in a free state).

(S28) The replacement page determination unit 112 determines whether the request source has been notified of a number of pages equal to the requested number. If the request source has been notified of a number of pages equal to the requested number, the process is terminated. If the request source has not been notified of a number of pages equal to the requested number, the process proceeds to step S22.

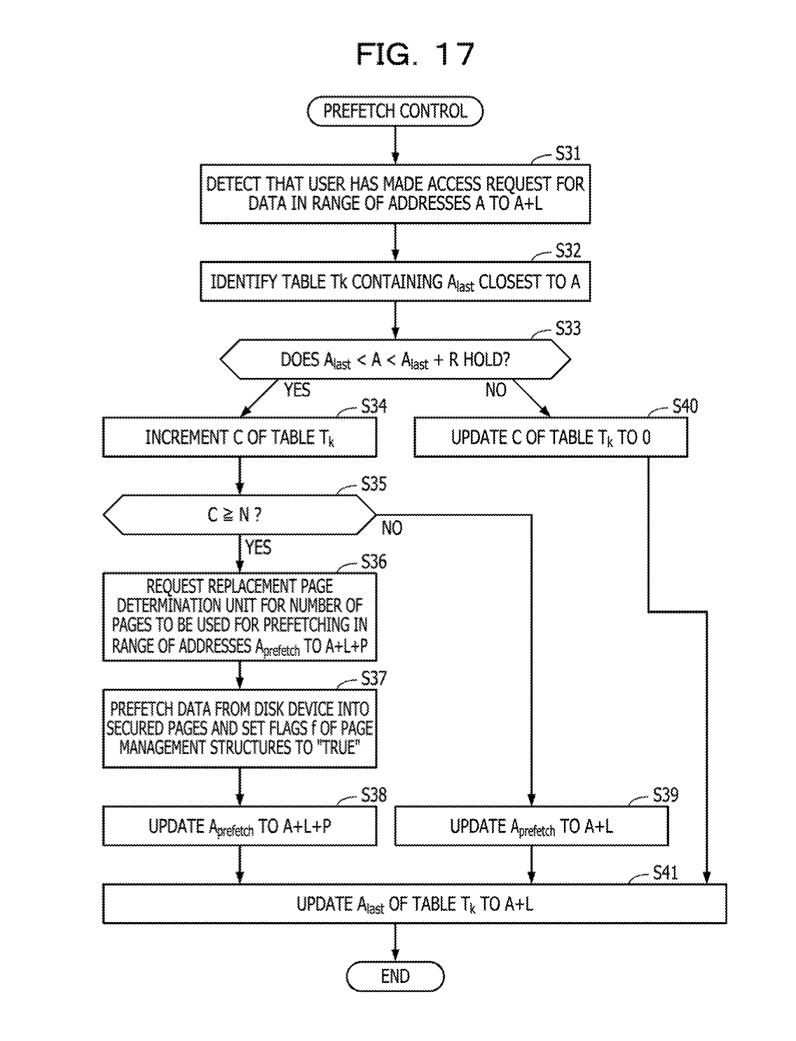

FIG. 17 is a flowchart illustrating an example of prefetch control. Hereinafter, the process illustrated in FIG. 17 will be described in accordance with step numbers.

(S31) The prefetch controller 113 detects that the user has made an access request for data in the range of addresses A to A+L. For example, a computer coupled via the network 20 to the storage 10 may be considered as the user. In addition, the range of addresses A to A+L indicates the range of logical addresses in the disk device 200. L represents an offset value for the logical address A, defining the endpoint of the range of addresses to be accessed.

(S32) The prefetch controller 113 identifies an access management table Tₖ (denoted as table Tₖ in FIG. 17) containing Aₗₐₛₜ that is closest to the logical address A.

(S33) The prefetch controller 113 determines whether Aₗₐₛₜ<A<Aₗₐₛₜ+R holds for the access management table Tₖ identified in step S32. If the expression holds, the process proceeds to step S34. If the expression does not hold, the process proceeds to step S40.

(S34) The prefetch controller 113 increments the counter C of the access management table Tₖ (adds one to the set value of the counter C).

(S35) The prefetch controller 113 determines whether the counter C is larger than or equal to N. If the counter C is larger than or equal to N, the process proceeds to step S36. If the counter C is not larger than or equal to N (smaller than N), the process proceeds to step S39.

(S36) The prefetch controller 113 requests the replacement page determination unit 112 for a number of pages to be used for prefetching in the range of addresses of A_{prefetch} to A+L+P (the range of logical addresses).

(S37) The prefetch controller 113 accepts notification of a number of pages equal to the requested number from the replacement page determination unit 112 (securing pages for storing prefetched data). The prefetch controller 113 prefetches data from the disk device 200 into secured pages and sets the flags f of the page management structures corresponding to the pages concerned to “true”. In addition, the prefetch controller 113 sets the logical address (setting the LBA value) from which the prefetched data has been read (the logical address of the disk device 200), in the page management structures corresponding to the pages concerned. Further, the prefetch controller 113 moves the page management structures of the pages in which the prefetched data is stored to the tail of LRU1 (changing the settings of pointers)

(S38) The prefetch controller 113 updates “A_{prefetch}” of the access management table Tₖ to “A+L+P”. Further, the process proceeds to step S41.

(S39) The prefetch controller 113 updates “A_{prefetch}” of the access management table Tₖ to “A+L”. This is because, owing to this access request, the logical addresses up to the logical address A+L have been accessed. Further, the process proceeds to step S41.

(S40) The prefetch controller 113 updates the counter C of the access management table Tₖ to zero. Further, the process proceeds to step S41.

(S41) The prefetch controller 113 updates “Aₗₐₛₜ” of the access management table Tₖ to “A+L”.

In such a way, the cache controller 110 maintains management with LRU1 for a page in which prefetched data is stored, among pages managed with LRU1, even when a cache hit has occurred in this page. In addition, for a page in which random data is stored, among pages managed with LRU1, the cache controller 110 changes the LRU list for managing this page from LRU1 to LRU2 when a cache hit has occurred.

Prefetched data is often used for reading data that is sequentially accessed, and thus, in many cases, the prefetched data is no longer referenced after being referenced one or more times in a certain short time period. That is, in many cases, a page in which prefetched data is stored is no longer accessed after being temporarily accessed at consecutive addresses. As described above, it is conceivable that, in a cache page management method in which LRU lists to be used are separated in accordance with the number of hits, so that useful data is protected, prefetched data and random data are handled equally. In particular, once a page of prefetched data is hit, registering the page on an LRU list of use (for example, LRU2) leads to a situation in which the prefetched data that is no longer accessed remains in cache.

Therefore, the cache controller 110 causes a page in which prefetched data is stored to remain under the management with LRU1 as described above. That is, the page management structure corresponding to a page in which prefetched data is stored is inhibited from being moved between LRU lists (moved from LRU1 to LRU2). With LRU2, the cache controller 110 manages a page in which random data with an actual result of a cache hit is stored, and does not manage a page in which prefetched data is stored. Consequently, it is possible to inhibit the page management structure of a page in which prefetched data is stored from remaining in LRU2. As a result, it is possible to inhibit prefetched data from remaining in the cache C1 to efficiently use the cache C1.

Here, in the example of the second embodiment, the cache controller 110 moves the page management structure of a page in which random data is stored from LRU1 to LRU2 when a cache hit has actually occurred once. However, in contrast to this, the cache controller 110 may perform this movement when a given number of two or more cache hits have actually occurred.

Note that although the storage 10 is illustrated in the second embodiment, a server computer or a client computer may have the functionality of the cache controller 110. That is, a server computer or a client computer may be considered as an example of the information processing apparatus 1 of the first embodiment.

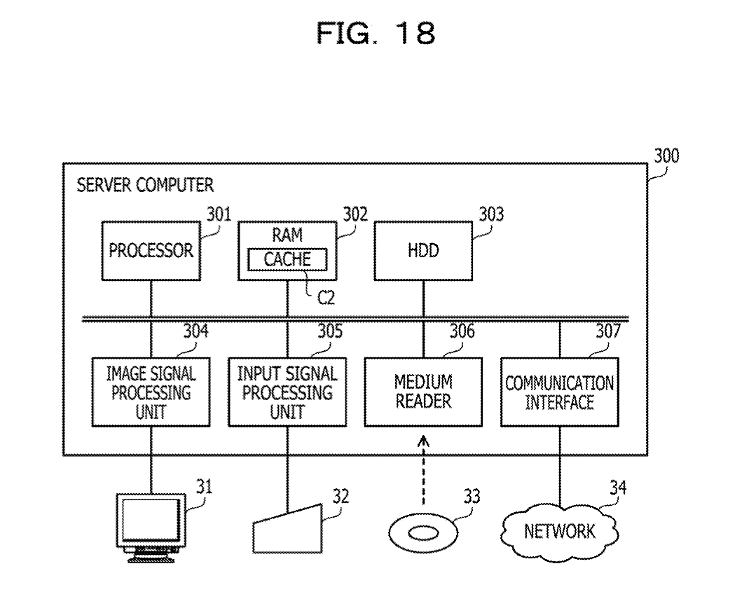

FIG. 18 is a diagram illustrating an example of hardware of a server computer. A server computer 300 includes a processor 301, RAM 302, an HDD 303, an image signal processing unit 304, an input signal processing unit 305, a medium reader 306, and a communication interface 307. Each unit is coupled to a bus of the server computer 300. A client computer is implementable using units similar to those of the server computer 300.

The processor 301 controls information processing of the server computer 300. The processor 301 may be a multiprocessor. The processor 301 is, for example, a CPU, a DSP, an ASIC, an FPGA, or the like. The processor 301 may be a combination of two or more elements among a CPU, a DSP, an ASIC, an FPGA, and the like.

The RAM 302 is a main storage of the server computer 300. The RAM 302 temporarily stores at least some of the OS program and application programs that the processor 301 is caused to execute. In addition, the RAM 302 stores various kinds of data that is used for processing executed by the processor 301.

The RAM 302 is provided with cache C2 for storing data read from the HDD 303. The cache C2, like the cache C1, is a set of pages into which a certain storage area of the RAM 302 is divided by a given size.

The HDD 303 is an auxiliary storage of the server computer 300. The HDD 303 magnetically writes and reads data to and from an integrated magnetic disk. The HDD 303 stores an OS program, application programs, and various kinds of data. The server computer 300 may also include another type of auxiliary storage such as flash memory or an SSD, and may also include a plurality of auxiliary storages.

The image signal processing unit 304 follows an instruction from the processor 301 to output an image to a display 31 coupled to the server computer 300. As the display 31, it is possible to use a cathode ray tube (CRT) display, a liquid crystal display, or the like.

The input signal processing unit 305 acquires an input signal from an input device 32 coupled to the server computer 300 and outputs the signal to the processor 301. As the input device 32, it is possible to use for example, a pointing device such as a mouse or a touch panel, a keyboard, or the like.

The medium reader 306 is a device that reads a program or data recorded on the recording medium 33. As the recording medium 33, it is possible to use, for example, a magnetic disk such as a flexible disk (FD) or an HDD, an optical disk such as a compact disc (CD) or a digital versatile disc (DVD), or a magneto-optical (MO) disk. In addition, as the recording medium 33, it is possible to use, for example, nonvolatile semiconductor memory such as a flash memory card. The medium reader 306, for example, follows an instruction from the processor 301 to store a program or data read from the recording medium 33 in the RAM 302 or the HDD 303.

The communication interface 307 performs communication with another device via a network 34. The communication interface 307 may be a wired communication interface or a wireless communication interface.

The server computer 300 may perform functionality similar to that of the cache controller 110 for data access to the HDD 303 when a program stored in the RAM 302 is executed by the processor 301.

Here, it is possible for the information processing of the first embodiment to be implemented by causing the controller 1a to execute programs. It is also possible for the information processing of the second embodiment to be implemented by causing the processor 101, 301 to execute programs. It is possible for the programs to be recorded on a computer-readable recording medium 21, 33.

For example, distributing the recording medium 21, 33 on which programs are recorded makes it possible to distribute the programs. In addition, the programs may be stored in another computer and be distributed over a network. A computer may, for example, store (install) programs recorded on the recoding medium 21, 33 or programs received from another computer in a storage such as the RAM 102 and the NVRAM 103 (or the RAM 302 and the HDD 303). A computer may read programs from this storage and execute the programs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory including a plurality of memory blocks, each of the plurality of memory blocks managed with either a first list or a second list, respectively, the first list storing information of a memory block storing a data read from a storage, the second list storing information of a memory block storing a data having a cache hit; and
a controller configured to refer a first memory block managed with the first list, maintain management of the first memory block with the first list when data of the first memory block is data that has been prefetched, and change a list with which the first memory block is managed from the first list to the second list when the data of the first memory block is data that has not been prefetched.

2. The information processing apparatus according to claim 1, wherein the controller is configured to move a list element corresponding to the first memory block to a tail of the first list if the data of the first memory block is data that has been prefetched, and move the list element corresponding to the first memory block to a tail of the second list if the data of the first memory block is data that has not been prefetched.

3. The information processing apparatus according to claim 1, wherein the controller registers, in the first list, the memory block to which data has been newly written.

4. The information processing apparatus according to claim 1, wherein the controller is configured to, once data that has been prefetched is newly written to any memory block, set, in a list element corresponding to the memory block, identification information denoting that the prefetched data has been written.

5. The information processing apparatus according to claim 1, wherein the controller is configured to, when there is no free memory block to which data is to be written, select which of the first list or the second list is to be used to acquire a memory block to which data is to be written, depending on a comparison between the number of list elements belonging to the first list and a limit of the number of list elements.

6. A cache control method comprising:
managing each a plurality of memory blocks with either a first list or a second list, respectively;
referring a first memory block managed with a first list;
maintaining management of the first memory block with the first list if data of the first memory block is data that has been prefetched; and
changing an list with which the first memory block is managed from the first list to a second list if the data of the first memory block is data that has not been prefetched.
